(19) United States
(12) Patent Application Publication
(10) Pub. No.: US 2026/0011172 A1
(43) Pub. Date: Jan. 8, 2026

(54) ANIMAL IDENTIFICATION AND FORECASTING SYSTEM AND METHOD

(71) Applicant: Plastic Research and Development Corporation, Birmingham, AL (US)

(72) Inventors: Jordan Deason, Trussville, AL (US); Jarrett Franklin, Birmingham, AL (US)

(21) Appl. No.: 18/763,868

(22) Filed: Jul. 3, 2024

(51) Int. Cl. G06V 40/10; A01K 29/00; A01M 31/00; G06V 20/52

(52) U.S. Cl. CPC G06V 40/10; A01K 29/005; G06V 20/52; A01M 31/002

(57) ABSTRACT

A system, and method thereof, is provided for identifying and forecasting animal activity. The method may comprise receiving the images from the camera to define image specific raw data; assimilating the image specific raw data with contemporaneous weather data; determining a mean rate of animal sightings for each of a plurality of prior time intervals associated with the assimilated image specific raw data using a first analytics model; minimizing a difference between observed sightings and predicted sightings based at least in part on outputs from the first analytics model using a second analytics model; receiving forecasted weather data for a plurality of future time intervals; and determining an amount of likely animal sightings for each of the plurality of future time intervals based at least in part on the outputs from the first analytics model and outputs from the second analytics model using a third analytics model.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

### 1. Field of the Invention

The present invention relates generally to animal monitoring cameras, otherwise known as trail cameras. More particularly, the present disclosure relates to animal identification and forecasting systems and methods.

### 2. Description of the Prior Art

Hunters often have access to multiple hunting locations, including various tree stands across different destinations or properties. To aid in determining the most promising hunting spot, many hunters utilize trail cameras, which capture images of the surroundings to help identify local animal populations. These cameras can be programmed to take pictures at set time intervals or when they detect a combination of heat signature and/or movement. However, current trail camera systems suffer from several shortcomings.

Existing trail camera systems lack sophisticated analytics capabilities. Instead of providing users with insightful analysis, these systems simply deliver raw image data, leaving users to interpret trends, patterns, or groupings on their own through manual methods.

As camera technology has advanced, so have trail cameras. The shift from film to digital cameras, capable of capturing digital images, has made transferring image data easier. However, it has also placed a burden on trail camera users to analyze and interpret a larger volume of images. Modern digital cameras not only generate more images, but they also include additional metadata such as time, date, location, and other relevant information. Processing both the digital images and the associated metadata to extract useful insights has become challenging and cumbersome.

### BRIEF SUMMARY

In view of at least some of the above-referenced problems in existing trail camera systems, and the like, an exemplary objective of the present disclosure is to provide a trail camera system, and method thereof, for identifying and forecasting animal activity. The exemplary such system may desirably reference contemporaneous and forecasted weather data when forecasting animal activity. The exemplary such system may desirably implement multiple analytics models, such as, for example, one or more of a Poisson distribution model, an ordinary least squares model, or a negative binomial distribution model. The exemplary such system may desirably aggregate data from a given camera with data from other cameras positioned within a predefined geographic area or cluster and determine peak activity times for the cluster based on the aggregated data. The exemplary such system may desirably generate a multiplier associated with the peak activity times for the cluster and adjust camera specific forecasted animal activity based on the multiplier. The exemplary such system may desirably feature an object detection model that tracks the coordinates of identified objects or animals and assigns a probability of a type of animal to each identified animal.

In a particular embodiment, an exemplary method of identifying and forecasting animal activity as disclosed herein may include (a) receiving images from at least one camera to define image specific raw data, the received images containing at least one animal; (b) assimilating the image specific raw data with contemporaneous weather data; (c) determining a mean rate of animal sightings for each of a plurality of prior time intervals associated with the assimilated image specific raw data using a first analytics model; (d) minimizing a difference between observed sightings of the at least one animal and predicted sightings based at least in part on outputs from the first analytics model using a second analytics model; (e) receiving forecasted weather data for a plurality of future time intervals; and (f) determining an amount of likely animal sightings for each of the plurality of future time intervals based at least in part on the outputs from the first analytics model and output from the second analytics model using a third analytics model.

In an exemplary aspect according to the above-referenced embodiment, step (f) of the method may further include or alternately determine a probability of an animal signing for each of the plurality of future time intervals based at least in part on the outputs from the first analytics model and output from the second analytics model using a third analytics model.

In an exemplary aspect according to the above-referenced embodiment, the method may further include identifying data of the image specific raw data to be cleansed and cleansing the identified data.

In another exemplary aspect according to the above-referenced embodiment, the identified data may include duplicative data associated with a grazing occurrence of the at least one animal.

In another exemplary aspect according to the above-referenced embodiment, the grazing occurrence may be determined by: dividing the image specific raw data into a plurality of areas defined by a gird being overlayed onto each of the received images; associating the at least one animal with a primary area of the plurality of areas for each of the received images; and comparing successive images of the received images taken within a predetermined time to determine whether the at least one animal remained a predefined group of the plurality of areas, the predefined group including the primary area.

In another exemplary aspect according to the above-referenced embodiment, the primary area may contain a center of mass of the at least one animal.

In another exemplary aspect according to the above-referenced embodiment, the predefined group may at least partially includes one or more secondary areas of the plurality of areas adjacent to the primary area.

In another exemplary aspect according to the above-referenced embodiment, the predetermined time may be between five seconds and thirty seconds.

In another exemplary aspect according to the above-referenced embodiment, prior to step (c), the method may further include aggregating the image specific raw data with data from other cameras positioned within a predefined geographic cluster.

In another exemplary aspect according to the above-referenced embodiment, the method may further include determining peak activity times for each cluster based on the aggregated image specific raw data.

In another exemplary aspect according to the above-referenced embodiment, the predefined geographic cluster may be defined by a circular area having a diameter of about seventy (70) miles.

In another exemplary aspect according to the above-referenced embodiment, the first analytics model may be a Poisson distribution model.

In another exemplary aspect according to the above-referenced embodiment, step (d) of the method may further include determining one or more residuals base on the determined mean rate of animal sightings from the first analytics model using the second analytics model.

In another exemplary aspect according to the above-referenced embodiment, the second analytics model may be an ordinary least squares model.

In another exemplary aspect according to the above-referenced embodiment, the third analytics model may be a negative binomial distribution model.

In another embodiment, an exemplary system for identifying and forecasting animal activity as disclosed herein may include a camera and a computer program product residing on a non-transitory computer readable medium and executable by one or more processors to direct performance of operations comprising: receiving the images from the camera to define image specific raw data; assimilating the image specific raw data with contemporaneous weather data; determining a mean rate of animal sightings for each of a plurality of prior time intervals associated with the assimilated image specific raw data using a first analytics model; minimizing a difference between observed sightings of the at least one animal and predicted sightings based at least in part on outputs from the first analytics model using a second analytics model; receiving forecasted weather data for a plurality of future time intervals; and determining an amount of likely animal sightings for each of the plurality of future time intervals based at least in part on the outputs from the first analytics model and outputs from the second analytics model using a third analytics model.

In an exemplary aspect according to the above-referenced embodiment, the computer program product may further be configured to identifying data of the image specific raw data to be cleansed and cleansing the identified data.

In another exemplary aspect according to the above-referenced embodiment, the identified data may include duplicative data associated with a grazing occurrence of the at least one animal.

In another exemplary aspect according to the above-referenced embodiment, the grazing occurrence may be determined by dividing the image specific raw data into a plurality of areas defined by a gird being overlayed onto each of the received images; associating the at least one animal with at least one area of the plurality of areas for each of the received images; and comparing successive images of the received images to determine whether the at least one animal remained in the at least one area of the plurality of areas.

In another exemplary aspect according to the above-referenced embodiment, the computer program product may further be configured to aggregating the image specific raw data with data from other cameras positioned within a predefined geographic cluster, and determining peak activity times for each cluster based on the aggregated image specific raw data.

In another exemplary aspect according to the above-referenced embodiment, the first analytics model is a Poisson distribution model, the second analytics model is an ordinary least squares model, and the third analytics model is a negative binomial distribution model.

In another embodiment, an exemplary method for identifying and forecasting animal activity as disclosed herein may include (a) associating a camera of a user with a predefined geographic cluster of a plurality of clusters; (b) aggregating image specific raw data from the camera with other image specific raw data from other cameras associated with the predefined geographic cluster; (c) determining at least one peak activity time based on the aggregated data associated with the predefined geographic cluster; and (d) providing the user with the at least one peak activity time.

In an exemplary aspect according to the above-referenced embodiment, the method may further include expanding the predefined geographic cluster to include additional clusters of the plurality of clusters proximate to the predefined geographic cluster; aggregating the aggregated data associated with the predefined geographic cluster with additional data associated with the additional clusters; and determining the at least one peak activity time based on the aggregated data associated with the predefined geographic cluster and the additional data associated with the additional clusters.

In another exemplary aspect according to the above-referenced embodiment, step (c) of the method may further include applying a Stochastic Relative Strength Index (RSI) to the aggregated data associated with the predefined geographic cluster.

In another exemplary aspect according to the above-referenced embodiment, each of the image specific raw data from the camera and the other image specific raw data from the other cameras may be associated with images containing at least one animal.

In another exemplary aspect according to the above-referenced embodiment, step (c) may further include determining a mean rate of animal sightings for each of a plurality of prior time intervals based on the aggregated data associated with the predefined geographic cluster.

In another exemplary aspect according to the above-referenced embodiment, the method may further include receiving a request from a user for forecasted animal activity for at least one future time interval; and determining an amount of likely animal sightings for the at least one future time interval based at least in part on the aggregated data associated with the predefined geographic cluster.

In another exemplary aspect according to the above-referenced embodiment, the method may further include adjusting the amount of likely animal sightings when the at least one future time interval falls within the at least one peak activity time.

Numerous other objects, features and advantages of the present disclosure will be readily apparent to those skilled in the art upon a reading of the following description when taken in conjunction with the accompanying drawings.

### BRIEF DESCRIPTION OF THE SEVERAL VIEWS OF THE DRAWINGS

FIG. 1 is a diagram of an embodiment of a system in accordance with the present disclosure.

FIG. 2 is a diagram of another embodiment of a system in accordance with the present disclosure.

FIG. 3 is a flowchart of an embodiment of a method in accordance with the present disclosure.

FIG. 4 is a diagram of an embodiment of an image received by a camera of the system in accordance with the present disclosure.

FIG. 5 is a diagram of another embodiment of an image received by a camera of the system in accordance with the present disclosure.

FIG. 6 is a diagram of another embodiment of an image received by a camera of the system in accordance with the present disclosure.

FIG. 7 is a diagram of another embodiment of an image received by a camera of the system in accordance with the present disclosure.

FIG. 8 is a diagram of another embodiment of an image received by a camera of the system in accordance with the present disclosure.

FIG. 9 is a diagram of an embodiment of a cluster model of the system in accordance with the present disclosure.

FIG. 10 is a diagram of another embodiment of a cluster model of the system in accordance with the present disclosure.

### DETAILED DESCRIPTION

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

Reference throughout this specification to “one embodiment,” “an embodiment,” “another embodiment,” “optional embodiment” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements (1)-(m)” where m is a number that may be the same or may be a different number than n.

As used herein, the term “computing device” may include a desktop computer, a laptop computer, a tablet computer, a mobile device such as a mobile phone or a smart phone, a smartwatch, a gaming console, an application server, a database server, or some other type of computing device. A computing device may include a physical computing device or may include a virtual machine (VM) executing on another computing device. A computing device may include a cloud computing system, a distributed computing system, or another type of multi-device system.

As used herein, the term “data network” may include a local area network (LAN), wide area network (WAN), the Internet, or some other network. A data network may include one or more routers, switches, repeaters, hubs, cables, or other data communication components. A data network may include a wired connection or a wireless connection.

As used herein, the term “computing platform” or “platform” may include a computing environment where a portion of software can execute. A computing platform may include hardware on which the software may execute. The computing platform may include an operating system. The computing platform may include one or more software applications, scripts, functions, or other software. The computing platform may include one or more application programming interfaces (APIs) by which different portions of the software of the platform may communicate with each other or invoke functions. The computing platform may include one or more APIs by which it may communicate with external software applications or by which external software applications may interact with the platform. The computing platform may include a software framework. The computing platform may include one or more VMs. The computing platform may include one or more data storages. The computing platform may include a client application that executes on an external computing device and that interacts with the platform in a client-server architecture.

As used herein, the terms “determine” or “determining” may include a variety of actions. For example, “determining” may include calculating, computing, processing, deriving, looking up (e.g., looking up in a table, a database or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions.

As used herein, the term “access,” “accessing”, and other similar terms may include a variety of actions. For example, accessing data may include obtaining the data, examining the data, or retrieving the data. Providing access or providing data access may include providing confidentiality, integrity, or availability regarding the data.

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described, such software application able to both send and receive pertinent performance data.

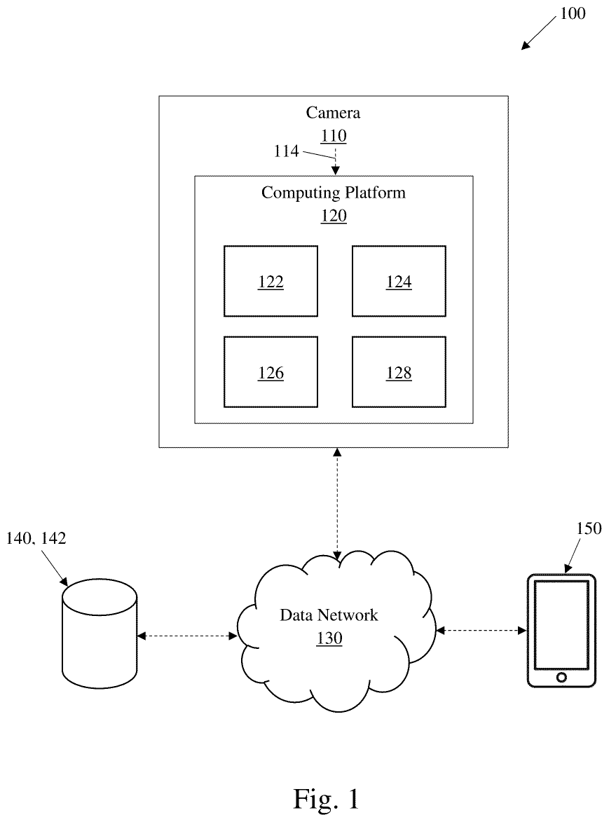

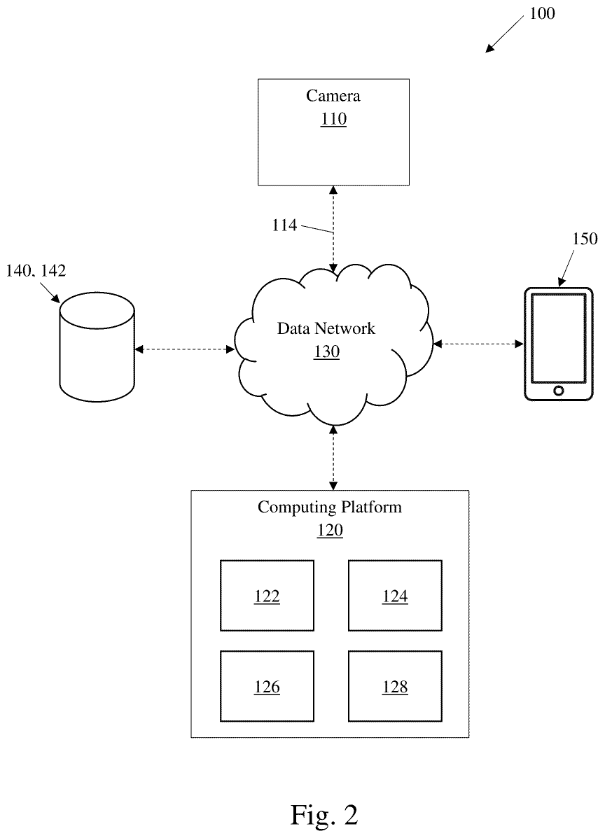

Referring to FIGS. 1-2, a system 100 for identifying and forecasting animal activity. The system may include a computer program product 120 configured to analyze data (e.g., image specific raw data) received from a one or more trail cameras 110 in light of contemporaneous weather data 140 received from a weather forecasting center for a plurality of prior time intervals and forecast future animal activity based at least in part on forecasted weather data 142 received from the weather forecasting center for a plurality of future time intervals. The one or more trail cameras 110 may also be referred to herein as one or more cameras 110 or a camera 110. The computer program product 120 may also be referred to herein as a computing platform 120. The pluralities of prior and future time intervals may be defined hourly, quarter-hourly, or some other time division. In certain optional embodiments, the camera 110 may including one or more weather sensors (not shown) configured to capture the contemporaneous weather data 140 locally.

In certain optional embodiments, as illustrated in FIG. 1, the computing platform 120 may be located locally at the camera 110. In other optional embodiments, as illustrated in FIG. 2, the computing platform 120 may be located remotely from the camera 110, with the system 100 further including a data network 130 for communicating with a transmitter of the camera 110. The computing platform 120 may include or reside on a non-transitory computer readable medium 122 and may be executable by one or more processors 124. The computing platform 120 may further include data storage 126. One or more of the contemporaneous weather data 140 or the forecasted weather data 142 may be received by the computing platform 120 using the data network 130.

The system 100, or more specifically, the computing platform 120 may include a user interface (UI) 128 executable on one or more of the computing platform 120 or a computing device 150 which may be in data communication with the computing platform 120 via the data network 130. The computing device 150 may be configured to execute a to access forecasted animal activity.

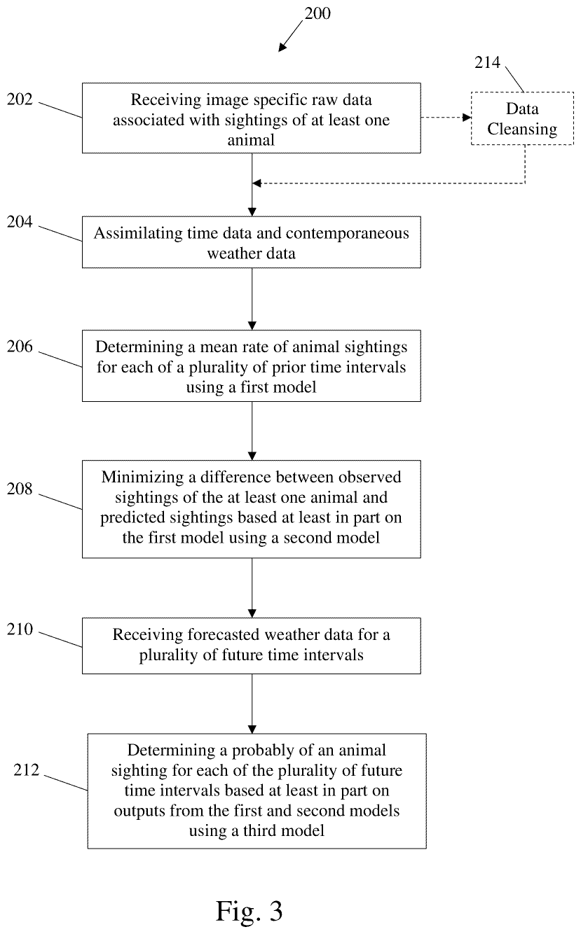

The computing platform 120 may be executable by the one or more processors 124 to direct performance of operations, which may be represented by a method 200 for identifying and forecasting animal activity, as illustrated in FIG. 3. As such, the method 200 is executable by the system 100.

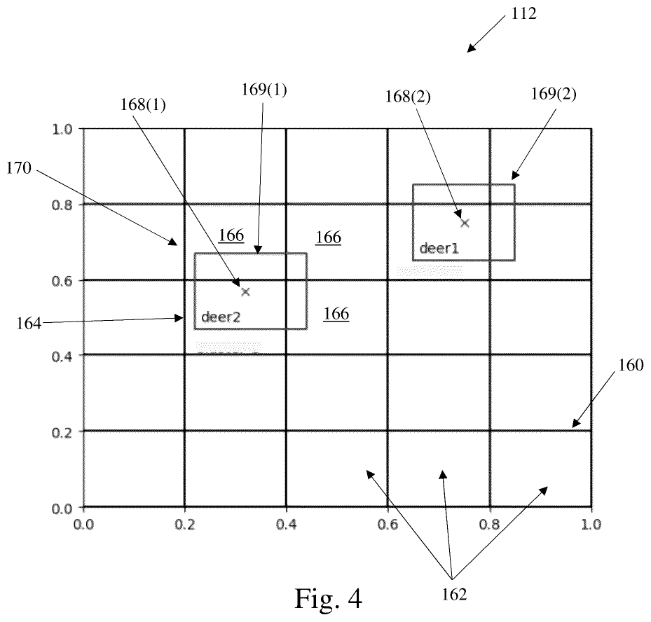

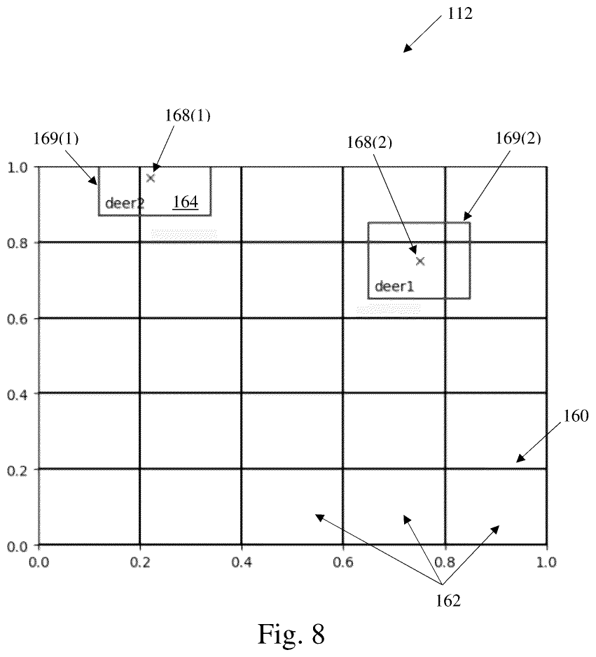

The method 200 may include (a) receiving 202 images 112 (shown in FIGS. 4-8) from the at least one camera 110 to define image specific raw data 114. The image specific raw data 114 may include GPS location data and timestamp data. The camera 110 may be configured to capture images 112 of at least one animal 102 (shown in FIGS. 4-8) when sensed by the camera 110 using smart tags. The camera 110 may include object detection software configured to identify each animal of interest in each captured image 112. As such, the received images 112 contain at least one animal. In other words, the captures images may contain more than one animal which is reflected in the image specific raw data 114. In certain optional embodiments, multiple cameras may be deployed such that animal activity can be forecasted for a geographic area.

The method 200 may further include (b) assimilating 204 contemporaneous weather data 140 with the image specific raw data 114. The contemporaneous weather data 140 may include temperature data (e.g., in Fahrenheit), pressure data (e.g., in millibars), wind speed data (e.g., in miles per hour), precipitation data (e.g., in inches), time data (generally hourly), and/or the like data. The aforementioned data my be grouped hourly.

The method 200 may further include (c) determining 206 a mean rate of animal sightings (μ) for each of a plurality of prior time intervals associated with the assimilated image specific raw data using a first analytics model. The first analytics model may be a Poisson Distribution analytics model, shown in formula (1):

$$μ = P ( X = k ) = \frac{{λ}^{k} {e}^{- λ}}{k !} \qquad ( 1 )$$

where X is the random variable representing the number of events (i.e., animal sightings), e is Euler's number which is approximately equal to 2.71828, k our number of events, and k! is a factorial of k.

Formula (1) may be executed for each of the plurality of prior time intervals with corresponding image specific raw data 114. Starting with the mean rate of animal sightings for each of the plurality of prior time intervals model, the method 200 may include determining the dependent variable lambda (λ) using a generalized linear model according to formula (2):

$$λ = \frac{( t - {μ}^{2} ) - μ}{μ} \qquad ( 2 )$$

The rate parameter λ may be used to calculate an auxiliary parameter (AUX) according to formula (3):

$$AUX = \frac{{( y - λ )}^{2} - λ}{λ} \qquad ( 3 )$$

where y is the count variable. This may be performed for every prediction (i.e. every user that requests a forecast for a certain location at a certain time). This may not be performed for zero activity clusters because the model may infer activity for regions which have no activity. Clusters 180 are discussed in more detail below.

The method 200 may further include (d) minimizing 208 a difference between observed sightings of the at least one animal 102 and predicted sightings based at least in part on outputs from the first analytics model using a second analytics model. The second analytics model may be an ordinary least squares analytics model, for example, a sum of squared residuals, which may be used to determine one or more residuals based on lambda (λ) according to formula (4):

$$SSR = {\sum }_{i = 1}^{n} {( {Y}_{i} - {\hat{Y}}_{i} )}^{2} \qquad ( 4 )$$

where n equals the total number of observations (i.e., the total number of hours used in the forecast model, specifically 240); Y is the value of observed sightings and Ŷ is the value of predicted sightings. This formula may be performed for each coefficient needed. IRLS is used to find the maximum likelihood estimates of a generalized linear model, and in robust regression to find an M-estimator, as a way of mitigating the influence of outliers in an otherwise normally-distributed data set, for example, by minimizing the least absolute errors rather than the least square errors. For example, all weather coefficients may be calculated during the iteratively reweighed least squares model when we fit the model. The count data and calculated auxiliary variable may be fitted to the ordinary least squares model and the resulting coefficient will be used as a dispersion parameter (α) (i.e., residuals) in the negative binomial regression model, as discussed below. The weather variables may be used after the dispersion parameter (α) is calculated.

The method 200 may further include (e) receiving 210 forecasted weather data 142 for a plurality of future time intervals. The forecasted weather data 142 may be received from a weather forecasting center via the data network 130. The forecasted weather data 142 may comprise a 10-day forecast having two-hundred-and-forty (240) hours. As such, the plurality of future time intervals may include two-hundred-and-forty (240) time intervals.

The method 200 may further include (f) determining 212 for each of the plurality of future time intervals based at least in part on the outputs from the first analytics model and output from the second analytics model using a third analytics model. The third analytics model may be a negative binomial distribution analytics model. As there are many times periods where no animals are observed, the negative binomial distribution analytics model may be used to calculate, more accurately, an amount of likely animal sightings (or an actual probability of successfully sighting an animal) for each of the plurality of future time intervals, according to formula (5):

$$P ( X = k ) = ( \begin{matrix}k + r - 1 \\ k\end{matrix} ) {{p}^{r} ( 1 - p )}^{k} \qquad ( 5 )$$

where k is the number of time periods and r is the number of successes expected.

Formula (5) may output an actual count of a specific number of animals for a specific time interval based on a previous set of observations (e.g., the image specific raw data). With every user request, the prediction may be scaled by dividing all predictions by the maximum prediction and multiplying the number by 4. In other optional embodiments, the multiplier may be different.

The method 200 may further include identifying data of the image specific raw data to be cleansed and cleansing 214 the identified data. The identified data may include duplicative data associated with a grazing occurrence of the at least one animal 102. The grazing occurrence may also be referred to herein as loitering. The computing platform 120 may eliminate repetitive data associated with the grazing occurrence such that only one data entry is recorded, rather than multiple entries for a same one of the at least one animal 102 within the predetermined time.

The grazing occurrence may be determined by (1) dividing the image specific raw data into a plurality of areas 162 defined by a grid 160 being overlayed onto each of the received images 112, as illustrated in FIGS. 4-8; (2) associating the at least one animal 102 with a primary area 164 of the plurality of areas 162 for each of the received images 112; and (3) comparing successive images of the received images 112 taken within a predetermined time to determine whether the at least one animal 102 remained within a predefined group 170 of the plurality of areas 162. The predefined group 170 may include the primary area 164. In certain optional embodiments, the predefined group 170 may only include the primary area 164 such that if the animal moves outside the primary area, it will be recorded as a new or “unobserved” animal. The primary area 164 may include a center of mass 165 of the at least one animal 102. In other optional embodiments, the predefined group 170 may further include one or more secondary areas 166 adjacent to the primary area 164 such that the animal will be recorded as a previously sited or “observed” animal.

The predetermined time may also be referred to herein as a grazing time. In certain optional embodiments, the predetermined time may be between five (5) seconds and one (1) hour. In other optional embodiments, the predetermined time may be between ten (10) minute and forty-five (45) minutes. In further optional embodiments, the predetermine time may be thirty (30) minutes. For each successive image that is linked to a first image due to a grazing occurrence, the primary area 164 and one or more secondary areas 166 may be defined when comparing the successive image to a following successive image. As such, the predetermined time may be reset for each successive image and a total grazing time for the at least one animal 102 may be determined and logged.

Every image 112 may be divided into a grid 160. The grid size is proportional to the image with a constant number of squares (e.g., areas 162). For example, a thumbnail will have the same number of areas as a high-resolution image such that every area on the grid 160 has a similar location label across all images.

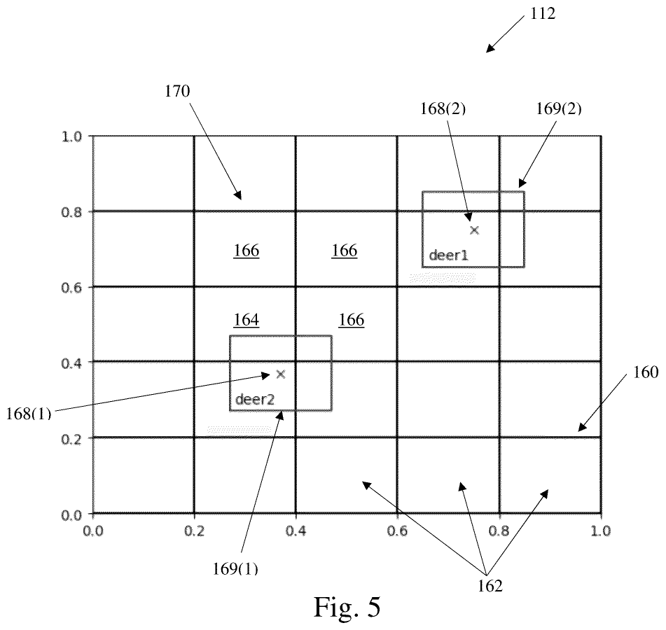

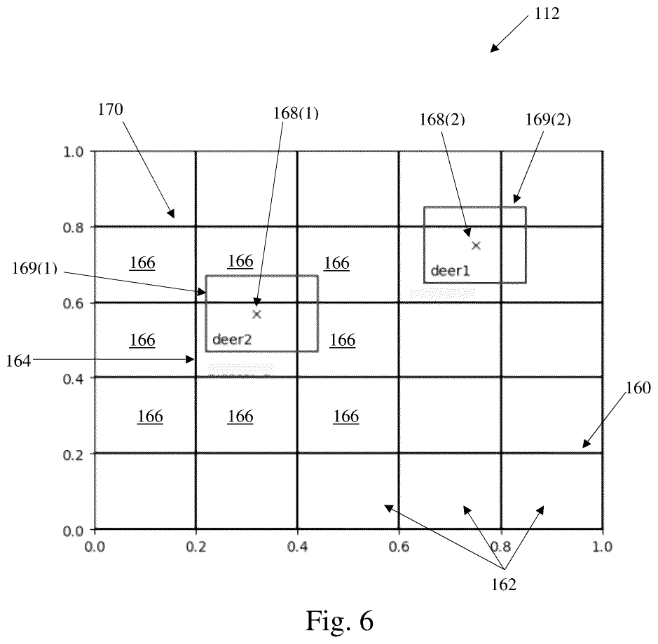

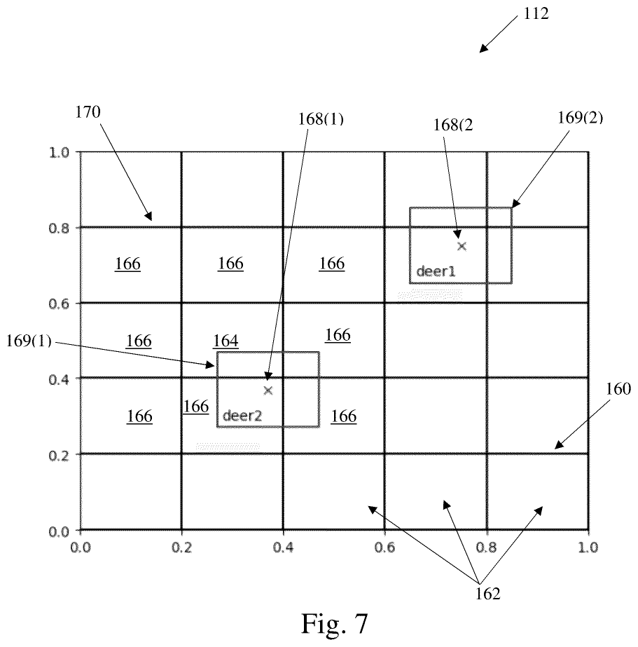

In certain optional embodiments, when comparing successive images of the received images 112, specifically those shown by comparing FIGS. 4 and 5, the one or more secondary areas 166 of the predefined group 170 may include only the adjustment areas of the primary area 164 closes to the center of mass 165 of the at least one animal 102. In other optional embodiments, when comparing successive images of the received images 112, specifically those shown by comparing FIGS. 6 and 7, the one or more secondary areas 166 of the predefined group 170 may include all of the areas adjacent to the primary area 164 (i.e., surrounding). In further optional embodiments (not shown), the one or more secondary areas 166 of the predefined group 170 may only include the area adjacent to the primary area 164 closest to the center of mass 165 of the at least one animal 102. In still further optional embodiments, the one or more secondary areas 166 of the predefined group 170 may include various combinations of areas adjacent to the primary area 164.

Step (a) of the method 200 may further include tagging the at least one animal 102 with a smart tag. The smart tags may be generated via an object detection model, for example executed by the computing platform 120, which looks at each image that is captured by the camera 110 and draws a box 169 around each object of interest. The smart tag may further identify the center of mass 168 of the object. The center of mass 168 may also be referred to herein as center coordinates or centroid of the object. The computing platform 120 may track the coordinates of each box's edges and employ an inferencing model, which may include artificial intelligence (AI), to infer what the object is (e.g., what type of animal the object is) and provide an associated probability that the inference is accurate. The smart tags may help divide the data by type of animal such that a generated forecast may be specific to a type of animal, such as a deer or the like.

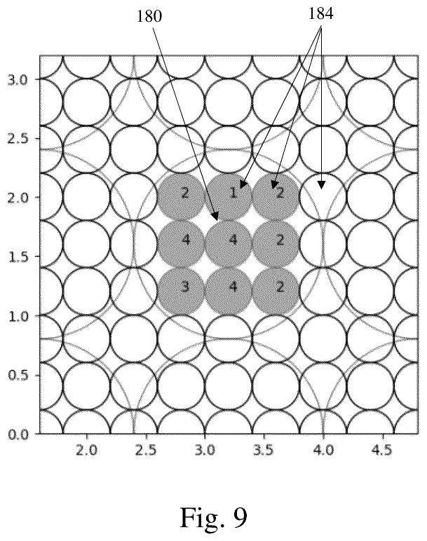

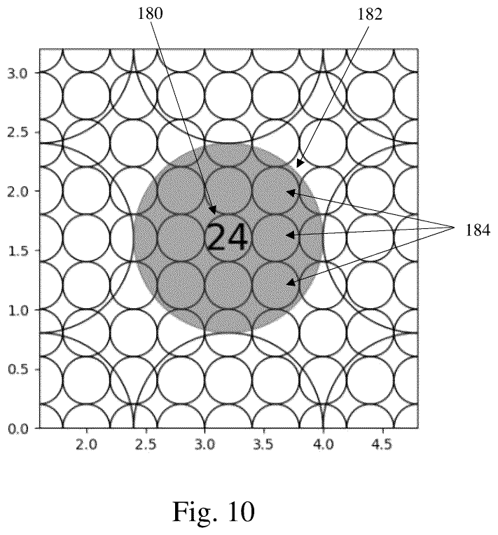

The method 200 may further include aggregating the image specific raw data 114 with data from other cameras positioned within a predefined geographic cluster 180, as illustrated in FIGS. 9-10. The method 200 may further include determining peak activity times for each cluster based on the aggregated image specific raw data. The peak activity times may also be referred to herein as peak activity dates. Regions of the country may be divided into a plurality of circular areas referred to as clusters. In certain optional embodiments, the shape of each cluster may be different, for example, square, rectangular, or some other shape. Each cluster 180 may be approximately seventy (70) miles in diameter. In other optional embodiments, a diameter or size of each cluster 180 may be different. Users who have provided the latitude and longitude of the cameras 110 may be assigned to or associated with one of the plurality of clusters 184. All activity within each cluster is summed over each one-hour period to get the activity count data. For areas with little to no activity, the cluster can be expanded (e.g., an enlarged cluster 182) such that activity estimates can be recalculated. The size of the cluster can be expanded to the point of giving a global estimate which includes all activity over all cameras for forecasting activity estimates. Historical weather is also recorded for every cluster. This historical activity may be processed nightly or more frequently.

A moving average of the grazing and occurrence activities' is calculated based on preceding twenty (20) hours. In other optional embodiments, the moving average may be based on the preceding forty-eight (48) hours, or some other time interval. A Stochastic Relative Strength Index (RSI) may be applied to aggregated data withing each cluster 180 to identify the time of each cluster's peak activity. The objective of the RSI may be to find anomalies in activity (specifically elevated activity) which meets certain threshold requirements. For example, the Stochastic RSI may be applied to find the peak activity times for a given cluster. The peak activity times may correspond to “rut dates” or breeding season. Rut is a periodic and often annually recurring state of certain male animals (such as deer or elk) during which behavior associated with the urge to breed is displayed.

Using the Stochastic RSI, the peak activity dates (or “rut dates”) are dates which activity meets the following criteria: (1) % K>=0.9 and % D>=0.9 and (2) % K>% D. % K may be associated with the lagging average of the moving or rolling average and % D may be associated with the leading average of the moving or rolling average. % D is equal to avg (activity) over the previous three (3) hours and % K is calculated over the previous fourteen (14) hours according to:

$$\% K = \frac{( activity - min ( activity ) )}{( max ( activity ) - min ( activity ) )}$$

Accordingly, % K may be true when current activity is at or above the 90th percentile of the previous fourteen (14) hours and % D may be true when current activity is at or above the 90th percentile of the previous three (3) hours, and % K>% D when % K crosses over % D. Each instance of occurrence over one (1) hour may be counted and summed over the week.

In certain optional embodiments, each cluster 180 may have up to two peak activity periods. For example, for clusters which contain at least ten (10) occurrences in one (1) week, the top two (2) highest weeks for each cluster may be selected and stored as the peak activity times (or “rut dates”). In other optional embodiments, each cluster 180 may have more than two peak activity periods. In further optional embodiments, each hour of the day for each cluster 180 include an activity score. These activity scores may be further divided by types of animals associated with said activity.

The Stochastic RSI may be used to calculate a multiplier which may be used to adjust the forecast. After the peak activity time (or “rut dates”) are determined for each cluster and the unobserved sightings data or duplicative data is removed, activity associated with the rut period may be compared with activity outside of the rut period over the previous year to determine the multiplier. The multiplier may be determined and applied hourly for the forecasted activity. When a user requests a forecast for a date and the date falls in the rut time period for the associated cluster, the forecast may be adjusted according based on the stored hourly multipliers for that cluster.

The Stochastic RSI is a momentum oscillator that is generally related to the speed and change of price movements of stocks. It operates on a scale from 0 to 100 and is typically used to identify overbought or oversold conditions in the stock market. An asset is generally considered overbought when the RSI is above 70 and oversold when it is below 30. Stochastic RSI is a technical analysis indicator used to identify trends in the price movements of assets. It's a combination of two popular indicators: the Stochastic Oscillator and the Relative Strength Index. The Stochastic Oscillator compares a particular closing price of an asset to a range of its prices over a certain period. It also operates on a 0 to 100 scale and is used to predict price turning points by comparing the closing price to its price range.

The method 200 may utilize a K-means clustering algorithm or model that takes a latitude and longitude of a camera 110 and groups the camera 110 with the closest cluster. The K-means model is used to group regions of interest into a given cluster 180. Each cluster may be approximately seventy (70) miles in diameter and all clusters have been pre-determined to cover all of North America or any other country or area of interest. As described above, activity may be aggregated by cluster. When a user requests a forecast for a certain latitude and longitude, the model will return the cluster which center point has the smallest distance to the requested latitude and longitude coordinate and match the user to that cluster.

In certain optional embodiments, the method 200 may include receiving a latitude and a longitude associated with a camera and assigning the camera to the appropriate cluster using the clustering model. The method 200 may further include retrieving the historical animal (e.g., deer) activity and the historical weather for the assigned cluster. With this data, the forecasting model may return the two-hundred-and-forty (240) hour forecast. From the forecasting model, the method 200 may check to see if any upcoming date are within the peak activity dates for the cluster. If a date falls in that range, the method 200 may apply the aforementioned multiplier to adjust the forecast. This analysis may then be returned to the user to assist in picking the best time to go hunting.

In certain optional embodiments, the determined amount of animal sightings from step (f) of the method 200 may be adjusted based on the multiplier as determined using the cluster model.

In certain optional embodiments, the method 200 may further include implementing an AI neural network module to perform and iteratively improve the forecasting analysis. In other optional embodiments, the AI neural network module may be configured to iteratively improve the confidence level determination associated with the determined amount of likely animal sightings from step (f) of the method 200 and/or outputs of the cluster model. In other words, the artificial intelligence neural network improves the accuracy, results, and automation of the system 100. Tuning of configurations and models, using the AI neural network module 158 or otherwise, may improve the system efficiency and accuracy.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatuses, systems, and methods described herein. Such equivalents are considered to be within the scope of this disclosure and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

These features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable media having program code embodied thereon.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions as may be described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present disclosure of new and useful systems and methods dynamically providing content, it is not intended that such references be construed as limitations upon the scope of this disclosure.

What is claimed is:

1. A method for identifying and forecasting animal activity, the method comprising:
(a) receiving images from at least one camera to define image specific raw data, the received images containing at least one animal;
(b) assimilating the image specific raw data with contemporaneous weather data;
(c) determining a mean rate of animal sightings for each of a plurality of prior time intervals associated with the assimilated image specific raw data using a first analytics model;
(d) minimizing a difference between observed sightings of the at least one animal and predicted sightings based at least in part on outputs from the first analytics model using a second analytics model;
(e) receiving forecasted weather data for a plurality of future time intervals; and
(f) determining an amount of likely animal sightings for each of the plurality of future time intervals based at least in part on the outputs from the first analytics model and output from the second analytics model using a third analytics model.

2. The method of claim 1, further comprising:
identifying data of the image specific raw data to be cleansed; and
cleansing the identified data.

3. The method of claim 2, wherein:
the identified data includes duplicative data associated with a grazing occurrence of the at least one animal.

4. The method of claim 3, wherein the grazing occurrence is determined by:
dividing the image specific raw data into a plurality of areas defined by a grid being overlayed onto each of the received images;
associating the at least one animal with a primary area of the plurality of areas for each of the received images; and
comparing successive images of the received images taken within a predetermined time to determine whether the at least one animal remained a predefined group of the plurality of areas, the predefined group including the primary area.

5. The method of claim 4, wherein:
the primary area contains a center of mass of the at least one animal.

6. The method of claim 4, wherein:
the predefined group at least partially includes one or more secondary areas of the plurality of areas adjacent to the primary area.

7. The method of claim 4, wherein:
the predetermined time is between ten minutes and forty-five minutes.

8. The method of claim 1, prior to step (c), the method further comprises:
aggregating the image specific raw data with other data from other cameras positioned within a predefined geographic cluster.

9. The method of claim 8, further comprising:
determining peak activity times for each cluster based on the aggregated image specific raw data.

10. The method of claim 8, wherein:
the predefined geographic cluster is defined by a circular area having a diameter of about seventy (70) miles.

11. The method of claim 1, wherein:
the first analytics model is a Poisson distribution model, the second analytics model is an ordinary least squares model, or the third analytics model is a negative binomial distribution model.

12. The method of claim 1, wherein step (d) further comprises:
determining one or more residuals base on the determined mean rate of animal sightings from the first analytics model using the second analytics model.

13. A system for identifying and forecasting animal activity, the system comprising:
a camera configured to capture images of at least one animal when sensed by the camera;
a computer program product residing on a non-transitory computer readable medium and executable by one or more processors to direct performance of operations comprising:
receiving the images from the camera to define image specific raw data;
assimilating the image specific raw data with contemporaneous weather data;
determining a mean rate of animal sightings for each of a plurality of prior time intervals associated with the assimilated image specific raw data using a first analytics model;
minimizing a difference between observed sightings of the at least one animal and predicted sightings based at least in part on outputs from the first analytics model using a second analytics model;
receiving forecasted weather data for a plurality of future time intervals; and
determining an amount of likely animal sightings for each of the plurality of future time intervals based at least in part on the outputs from the first analytics model and outputs from the second analytics model using a third analytics model.

14. A method for identifying and forecasting animal activity, the method comprising:
(a) associating a camera of a user with a predefined geographic cluster of a plurality of clusters;
(b) aggregating image specific raw data from the camera with other image specific raw data from other cameras associated with the predefined geographic cluster;
(c) determining at least one peak activity time based on the aggregated data associated with the predefined geographic cluster; and
(d) providing the user with the at least one peak activity time.

15. The method of claim 14, further comprising:
expanding the predefined geographic cluster to include additional clusters of the plurality of clusters proximate to the predefined geographic cluster;
aggregating the aggregated data associated with the predefined geographic cluster with additional data associated with the additional clusters; and
determining the at least one peak activity time based on the aggregated data associated with the predefined geographic cluster and the additional data associated with the additional clusters.

16. The method of claim 14, wherein step (c) further includes:
applying a Stochastic Relative Strength Index (RSI) to the aggregated data associated with the predefined geographic cluster.

17. The method of claim 14, wherein:
each of the image specific raw data from the camera and the other image specific raw data from the other cameras is associated with images containing at least one animal.

18. The method of claim 14, wherein step (c) further includes:
determining a mean rate of animal sightings for each of a plurality of prior time intervals based on the aggregated data associated with the predefined geographic cluster.

19. The method of claim 14, further comprising:
receiving a request from a user for forecasted animal activity for at least one future time interval; and
determining an amount of likely animal sightings for the at least one future time interval based at least in part on the aggregated data associated with the predefined geographic cluster.

20. The method of claim 19, further comprising:
adjusting the amount of likely animal sightings when the at least one future time interval falls within the at least one peak activity time.
